(19) United States
(12) Patent Application Publication
(10) Pub. No.: US 2013/0013349 A1
(43) Pub. Date: Jan. 10, 2013

(54) METHOD AND APPARATUS FOR SELECTING TRAVEL RELATED SERVICES

(76) Inventor: Stephen L. Tucker, Aurora, CO (US)

(21) Appl. No.: 13/176,211

(22) Filed: Jul. 5, 2011

(51) Int. Cl. G06Q 50/14; G06Q 10/02

(52) U.S. Cl. 705/5

(57) ABSTRACT

A method and apparatus for selecting travel related services. The method includes the step of determining a plurality of travel related services that a consumer of such services can select for their own use. Each service has a start and end date. The services are stored in a database from which they are published to consumers. Consumers may then select the services of interest to them. Should a consumer not be able to use the selected service within its start and end date, the consumer may make the service available to other consumers for selection. An associated apparatus is provided to implement the process.

### TECHNICAL FIELD

The present invention is generally directed to the field of travel and travel related services and more particularly, is directed to a method and apparatus for planning and purchasing such travel and travel related services by purchasing inexpensive options.

### BACKGROUND OF THE TECHNOLOGY

The financial crisis of 2008 has created the need for a new way of marketing travel and entertainment products. People don't have the same level of discretionary income that they had before the financial crash. The present invention provides a new concept for travel and resort-style living. This concept does not require full ownership but carries many similar benefits. The present invention represents the first substantial innovation in marketing travel and entertainment related services since the creation of time-share and fractional ownership many years ago.

Existing travel marketing methods are not affordable or sustainable in today's economy. Time-share cost includes an upfront fee of on average $5,000 to $25,000 for a week, yearly assessments, and then minimum costs for the stay. Fractional sales include an initial purchase ranging from $100,000 to $500,000 for 1½ to 3 months, with expensive annual assessments and minimal per stay costs. Whole ownership is very expensive and dictates where a person will spend most of his or her vacation or retirement time. It includes the cost of initial purchase, management, security, taxes, insurance and yearly or monthly home owner's fees and assessments.

There is very little real equity opportunity in current destination ownership models. Customers have been sold property ownership partially on the notion of long term equity and value. In the current economic conditions, there is very little equity in time-shares, fractional, and even in full ownership in many cases.

Thus, there is a need in the art for an improved method and apparatus for planning and purchasing travel and travel related services which overcome the above noted problems and deficiencies related to current approaches used to acquire such services.

The novel features of the present invention are set out with particularity in the following detailed description of the preferred embodiment. However, the invention will be understood more fully and clearly from the detailed description of the invention as set forth in the accompanying drawings in which:

### BRIEF DESCRIPTION OF THE DRAWINGS

FIG. 1 is a block diagram of the system architecture of one embodiment of an apparatus which implements the method of the present invention;

FIG. 2 is a block diagram of a clearing house software application in accordance with one embodiment of the present invention;

FIG. 3 is a block diagram of an option store software application in accordance with one embodiment of the present invention;

FIG. 4 is a block diagram of a membership software application in accordance with one embodiment of the present invention;

FIG. 5 is a block diagram of the lifecycle of a travel option in accordance with one embodiment of the present invention; and

FIG. 6 is a block diagram of the lifecycle of an event option in accordance with one embodiment of the present invention.

### DETAILED DESCRIPTION OF THE PREFERRED EMBODIMENT

The present invention will now be described with reference to the accompanying drawings.

As used in the present invention, the term “Option” refers to a privilege acquired, as by the payment of a premium or consideration, within a specified time, the carrying out of a transaction upon stipulated terms; the right, as granted in a contract or by an initial payment, to acquire something in the future. For example: “We bought one lot and took a 90-day option on an adjoining one.”

The term “Destination Option” refers to an option for a fixed length stay occurring at a yearly frequency. The options must be exercised 6-9 months before travel will occur.

The term “Entertainment Option” refers to an option for a particular season of theater, music, or other type of entertainment. This option secures the right to purchase season tickets at a discounted rate.

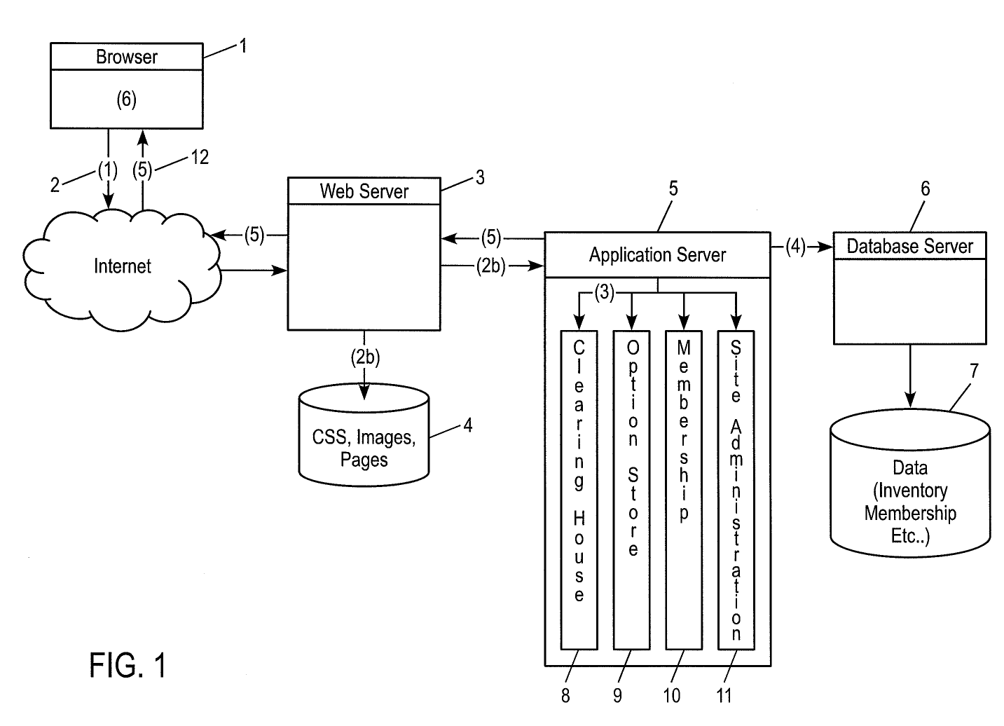

FIG. 1 is a block diagram of the system architecture of one embodiment of an apparatus which implements the method of the present invention. As illustrated in FIG. 1, a user using web browser 1 sends a request 2 for a page or resource from a website located on web server 13. As is known in the art, the request is propagated over the Internet to web server 13.

Web server 13 determines how to process the request. Static resources such as images, CSS and static web pages are read from a storage device 4 connected to web server 13, as one of ordinary skill in the art would understand, and returned to web browser 1 via the Internet.

Requests for dynamic resources are forwarded to application server 5. Application server 5 passes the request to the correct web application (Clearing House Application 8, Option Store Application 9, Membership Application 10, Site Administrator Application 11) as dictated by the user request. The appropriate web application constructs a response 12 to the user request 2 using data from database server 6 when necessary. Database server 6 has access to a number of data tables 7 which provide needed information for the web application to construct the response 12.

Response 12 is passed back to the user's browser 1 via application server 5, webs server 13 and the Internet. Browser 1 then displays response 12 to the user.

As known in the art, web server 13, application server 5 and database server 6 are independent pieces of software which can be installed on the same computer or different computers. This provides systems administrators the flexibility required to scale the system architecture as usage grows.

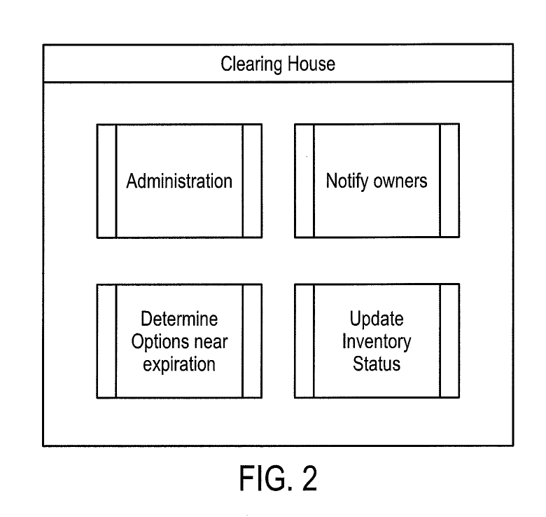

FIG. 2 is a block diagram of Clearing House Application 8. Clearing House Application 8 supports the following core functionalities:

(1) Determining Options that are near expiration and notifying owners;

(2) Allowing owners to offer owned options in the clearing house by updating the inventory status internally;

(3) Allowing users to trade owned options with other users;

(4) Providing Clearing House administration capabilities; and

(5) Utilizing the Option store to offer timeslot inventory.

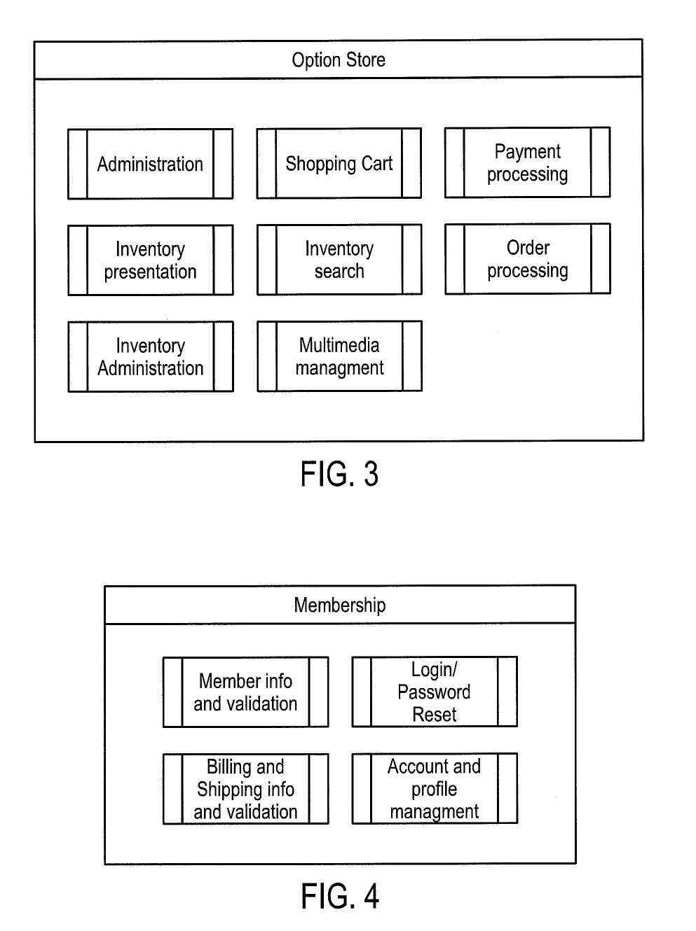

FIG. 3 is a block diagram of Option Store Application 9. Option Store Application 9 is utilized for the e-commerce functionality of the website. It is capable of typical store functionality including:

(1) Payment and Billing information gathering and storage;

(2) Shopping cart functionality;

(3) Inventory presentation;

(4) Inventory Search;

(5) Inventory Administration;

(6) Multimedia management;

(7) Store Administration; and

(8) Order processing.

FIG. 4 is a block diagram of Membership Application 10. Membership Application 10 provides the following functionality:

(1) Member information and validation;

(2) Login/Password Reset;

(3) Account and profile management; and

(4) Billing and Shipping information validation.

Site Administration Application 11 provides administrators of the system the ability to change site-wide settings and access the content management system to update page content, store settings, and other settings.

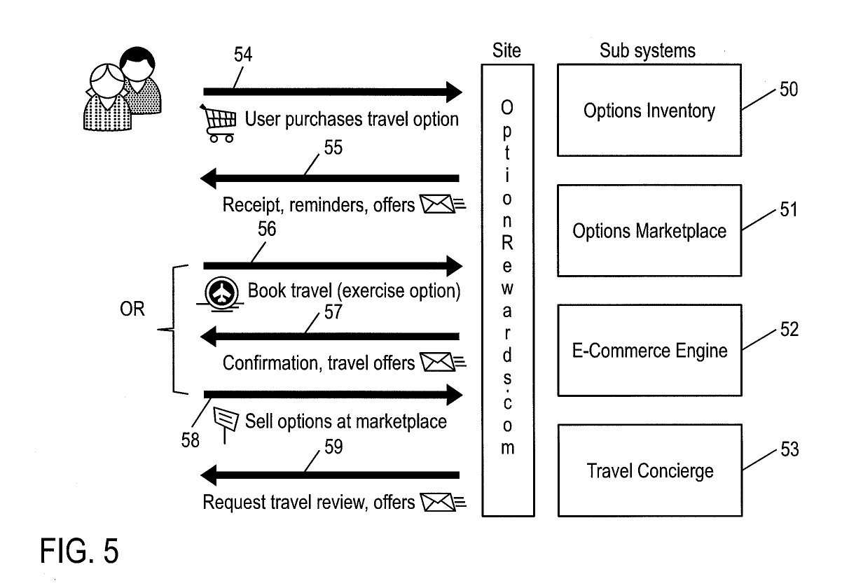

FIG. 5 is a block diagram of the lifecycle of a travel option. As shown in FIG. 5, Options Inventory 50 stores all of the available options. Options Marketplace 51 represents the options marketplace. In accordance with the present invention, a travel option can be for 1 or more accommodations for a stay of a minimum number of days to a maximum number of days. In one embodiment of the present inventions, a travel option can be exercised once per year for between 1-10 years depending on the purchase. Travel options are priced based on class and number of years.

E-Commerce Engine 52 is setup to receive payments from those wishing to purchase a travel option as those of ordinary skill in the art would understand.

Travel Concierge 53 is a referral system that links to other providers of related travel and leisure services.

Arrows 54-59 shown in FIG. 5 illustrate the interchange between a user and the system of the invention.

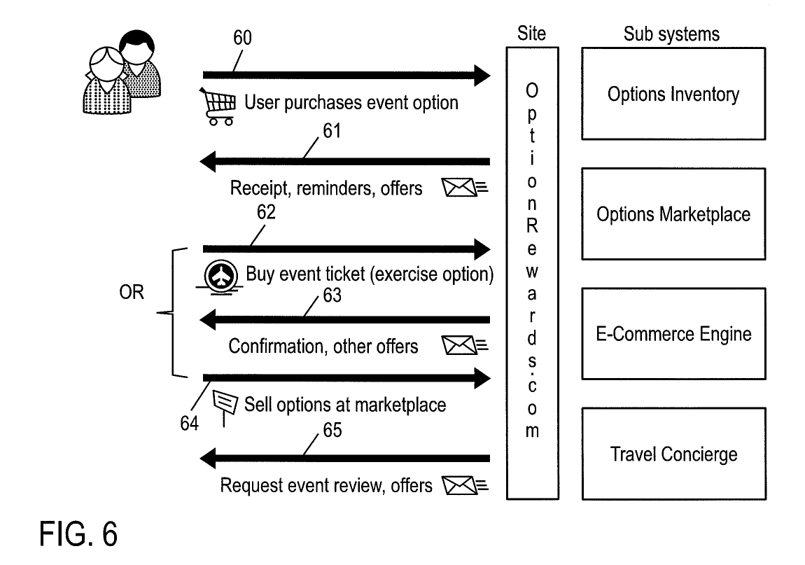

FIG. 6 is a block diagram of the lifecycle of an event option in accordance with the present invention. An event option is for one event or one series of events (e.g. season tickets to theater). Arrows 60-65 shown in FIG. 6 illustrate the interchange between a user and the system of the invention with respect to an event option.

The system and method of the present invention provides a new level of travel planning and flexibility to the consumer. It allows people to not be tied down to one location. The system and method also allows for a much lower investment in purchasing travel options. The investment is much lower than the investment need for full or fractional ownership of a property or the cost of a time-share or destination resort club.

Vacationers, retirees, or persons looking for a second home fit perfectly into the system and method of the present invention. For a minimal cost, a person can hold several options in different locations and pay no up-front purchase price, no maintenance, or yearly assessment fees, no mortgage, but receive a discounted rental fee.

Unlike competing travel marketing methods, purchasing options is very low risk. One does not have a large purchase price, regular maintenance fees and dues, etc . . . In addition, if one is unable to exercise the option purchased he or she will have the ability to put that option up for sale in the marketplace to minimize the loss of the investment.

While the foregoing specification teaches the principles of the present invention, with examples provided for the purpose of illustration, it will be appreciated by one skilled in the art from reading this disclosure that various changes in form and detail can be made without departing from the true scope of the invention.

I Claim:

1. A method of selecting travel related services, said method comprising the steps of:
determining a plurality of travel related services having a start date and an end date;
storing said travel related services in a database;
a publication process for publishing from said database the availability of said travel related services to consumers of said travel related services based on said start date and said end date;
a selection process for allowing said consumers to select ones of said travel related services for their own use; and
a transfer process for allowing travel related services selected by one of said consumers to be transferred to another of said consumers.
